(19) United States
(12) Patent Application Publication
(10) Pub. No.: US 2026/0191151 A1
(43) Pub. Date: Jul. 9, 2026

(54) GREENHOUSE THERMAL CONTROL

(71) Applicant: SENSEI AG HOLDINGS, INC., Santan Monica, CA (US)

(72) Inventor: W. Daniel Hillis, Santa Monica, CA (US)

(21) Appl. No.: 18/868,316

(22) PCT Filed: May 30, 2023
(86) PCT No.: PCT/US2023/067622

§ 371 Date: Nov. 22, 2024

Related U.S. Application Data
(60) Provisional application No. 63/346,531, filed on May 27, 2022.

(51) Int. Cl. A01G 9/24; A01G 9/14; A01G 9/22

(52) U.S. Cl. CPC A01G 9/246; A01G 9/1423; A01G 9/22

(57) ABSTRACT

A greenhouse thermal control mechanism comprises an under-table airflow system that is enabled in embodiments by robotically moved tables. An internal shading system may also be included. The under-table arrangement defines a plenum from which conditioned air rises to maintain uniform plant temperature. The conditioned air rises vertically from the plenum and is evenly circulated among each of the plants as it rises. As a result, the coolest (or warmest) air is evenly circulated directly on the plants. Each plant is cooled (or heated) in the same way. There is no significant thermal differential between the plants because any warming (or cooling) of the conditioned air occurs as the air rises evenly through the plants.

### CROSS-REFERENCE TO RELATED APPLICATION(S)

This application claims priority to U.S. provisional patent application Ser. No. 63/346,531, filed May 27, 2022, which application is incorporated by reference herein in its entirety by this reference thereto.

### TECHNICAL FIELD

Various of the disclosed embodiments concern greenhouse thermal control.

### BACKGROUND

Greenhouses must provide a nurturing environment for the plants that are grown within them. For example, a greenhouse must maintain an appropriate and stable ambient temperature if the plants in the greenhouse are to thrive. However, given the wide range of temperatures and thermal build up in a greenhouse, e.g. the greenhouse effect, thermal mediation in a greenhouse can be difficult.

For example, consider the following requirements in the Coachella Valley of California: The daytime temperature during the summer is often over 100° F., yet during winter nights temperatures drop to the low 40s. Further, a large greenhouse may have several megawatts of solar load.

A typical greenhouse includes a ventilation scheme that blows cooled/heated air from one end of greenhouse and allows the air to heat/cool the greenhouse until it exits another end of the greenhouse. High ceilings are provided to increase thermal mass of air.

### SUMMARY

Embodiments of the invention provide a greenhouse thermal control mechanism comprising an under-table airflow system that is enabled in embodiments by robotically moved tables. An internal shading system may also be included.

The tables that support the plants in the greenhouse create an under-table vault that constitutes a plenum from which conditioned air rises to maintain uniform plant temperature. In a conventional greenhouse, treated air is blown across the plants horizontally. As such, when cooler (or warmer) air is introduced into the greenhouse those plants nearest the conditioned air source receive cooler (or warmer) air, while those plants further away from the conditioned air source receive air that is not as cool (or warm) as the air was when it was first introduced into the greenhouse. As a result, the plants are not uniformly cooled (or warmed). To compensate for this, the air introduced into the greenhouse is often over cooled (or over heated). This exacerbates the thermal differential across the population of greenhouse plants and increases energy costs.

In embodiments of the invention, conditioned air that rises vertically from the plenum is evenly circulated among each of the plants as it rises. As a result, the coolest (or warmest) air is evenly circulated directly on the plants. Each plant is cooled (or heated) in the same way. Thus, in embodiments of the invention there is no significant thermal differential between the plants because any warming (or cooling) of the conditioned air occurs as the air rises evenly through the plants. In other embodiments of the invention, a series of operable vents in each of the tables may be adjusted to alter the volume and/or direction of air flow as desired, e.g. to provide different cooling (heating) profiles for the plants on each table.

A further advantage of this approach is that a greenhouse requires much less cooling (or heating) and thus uses less energy because it is not necessary to over cool (or overheat) the air introduced into the greenhouse to compensate for changes in temperature as the air travels horizontally across the greenhouse as in conventional systems.

### BRIEF DESCRIPTION OF THE DRAWINGS

FIGS. 1A and 1B show thermal variability in a greenhouse using a conventional cooling system (FIG. 1A) and using the herein disclosed under-table cooling system (FIG. 1B);

FIG. 2 is a schematic representation of a greenhouse showing the circulation of conditioned air according to the invention;

FIG. 3 is a schematic representation of a greenhouse showing a walkway;

FIG. 4 is a schematic representation of a greenhouse showing the tables and resilient seals; and

FIG. 5 is a schematic diagram showing an indoor shade arrangement for use in a greenhouse according to the invention.

### DETAILED DESCRIPTION

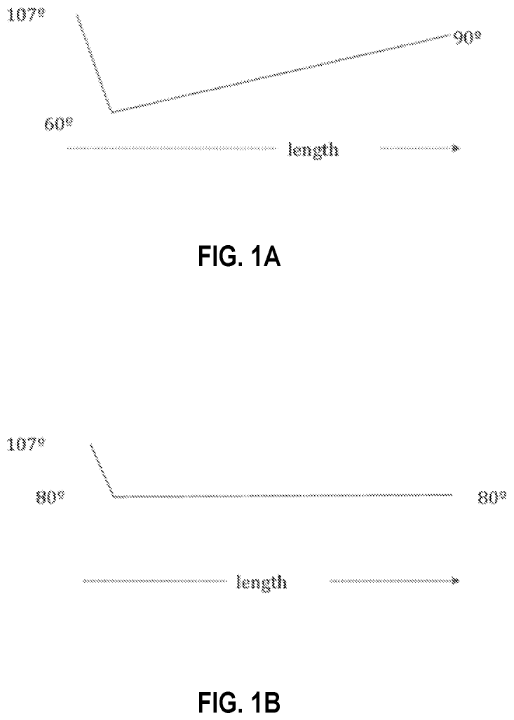

FIGS. 1A and 1B show thermal variability in a greenhouse using a conventional cooling system (FIG. 1A) and using the herein disclosed under-table cooling system (FIG. 1B).

Conventional greenhouse cooling/heating systems bring all air to a cooler/warmer temperature subjecting the plants in the greenhouse to a non-uniform temperature. As shown in FIG. 1A, in a greenhouse having an ambient temperature of 107° air cooled to 60° increases in temperature as it traverses the greenhouse horizontally until it reaches a temperature of goo at a far end of the greenhouse from the air entry point. As such, some plants are cooled to 60°, and other plants are only cooled to 90°.

Further, in some conventional greenhouses it is necessary to vent heated air, such that the air may turn over more than once per minute. Such approach works poorly with internal shades if there is any downward airflow e.g. convective loops.

Embodiments of the invention provide a greenhouse thermal control mechanism comprising a plenum that is defined by an under-table airflow system that may be enabled by robotically moved tables. Under-table cooling/heating brings air only to a required temperature, subjecting the plants in the greenhouse to a uniform temperature. As shown in FIG. 1B, in a greenhouse having an ambient temperature of 107° air cooled to 80° is equally distributed at 80° to all of the plants in the greenhouse as it rises vertically from under the tables holding the plants in the greenhouse. As such, all of the plants are cooled to the same temperature, i.e. 80°.

Further, such approach vents hot air only and air turns over at about half the rate of that for conventional greenhouses. Such approach works well with internal shades.

A typical greenhouse contains several tables on which plants are grown. Embodiments of the invention elevate the tables and put them together such that the tables form a continuous plenum between the ground and the tabletops. Conditioned air, either warmed or cooled, is then blown under the tables. The conditioned air rises around the plants through diffusers in the tables, rises upward, goes past any shading system, and then exits through vents in the greenhouse roof. In other embodiments of the invention, a series of operable vents in each of the tables may be adjusted to alter the volume and/or direction of air flow as desired, e.g. to provide different cooling (heating) profiles for the plants on each table. While the plants are cooled (heated) with air at the same temperature, individual plants may be cooled (heated) differently due to the adjustments made to the vents.

In embodiments of the invention the tables can be moved to open up a space between the tables and an aisle can be positioned in between the tables. Such movement may be effected robotically, mechanically, or manually. The aisle maintains the integrity of the plenum so that the continuity of the plenum is not broken by the introduction of the aisle. As discussed below, provision is made for moving the tables, sliding the tables, and moving the aisles. In embodiments the tables are attached to plumbing and electrical or other utilities, e.g. for water, artificial lighting, etc.

In embodiments the tables are attached by tethers at one end of the table that allow the tables to be moved to the left or the right to make room for the aisle as it is shifted between the tables. In embodiments, the tables have a mechanism for adjusting the flow of air between the pressurized plenum below and above. As discussed below, the aisle may have one or more fans in it that make up for any pressure differential between one side of the aisle and the other, i.e. the fans make up for pressure difference that would be created by the plenum and mitigate that pressure difference.

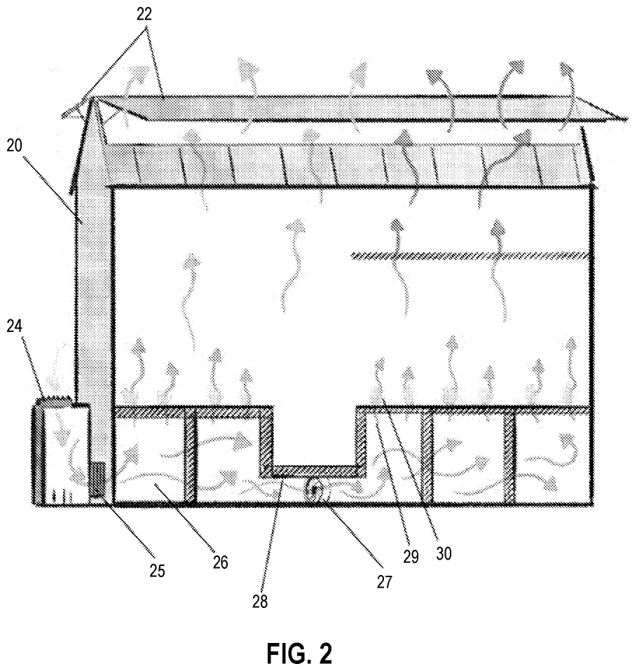

FIG. 2 is a schematic representation of a greenhouse showing the circulation of conditioned air according to the invention. In FIG. 2, a greenhouse 20 includes an air conditioner 24 that cools or warms, as appropriate, the air that it draws into the greenhouse. The conditioned air enters the greenhouse through a vent 25 and is circulated horizontally beneath a plurality of greenhouse tables 29. The greenhouse tables define a plenum 26 between the tabletops and the ground. As the conditioned air moves horizontally through the plenum is rises through vents in the tables and/or through gaps between the tables to cool or heat the plants 30 in the greenhouse.

The plenum maintains the conditioned air at a relatively constant temperature, i.e. there is little or no temperature differentiation within the plenum. As noted above, the distribution of air from the plenum may be constant or it may be individually adjusted by variably positioning and/or opening or closing one or more air exhaust vents 21 along or about the table surface. In this way, a different quality of conditioned air can be provided to the plants on each table as is appropriate for such plants and different crops having different cooling (heating) requirements can therefore be successfully grown at the same time within a greenhouse. Those skilled in the art will appreciate that any number of exhaust vents may be positioned at any desired locations among the tables to control and alter air flow from the plenum as desired.

In embodiments, the vents may be manually adjusted. In other embodiments, the vents may be electrically operated. In such embodiments, each vent may be individually or automatically adjustable in response to sensed local conditions at different locations within the greenhouse.

Adjustable vents 22 in the roof allow warm air to escape the greenhouse. Exhaust fans may be associated with the roof vents. As discussed below air may also be drawn into the greenhouse through the vents in the greenhouse roof. Reversible exhaust fans may be used in such embodiment, In some embodiments of the invention, a walkway 28 may be provided to allow access to the plants. A fan 27 may be provided to compensate for a pressure differential that results from the air restriction in the plenum caused by the walkway.

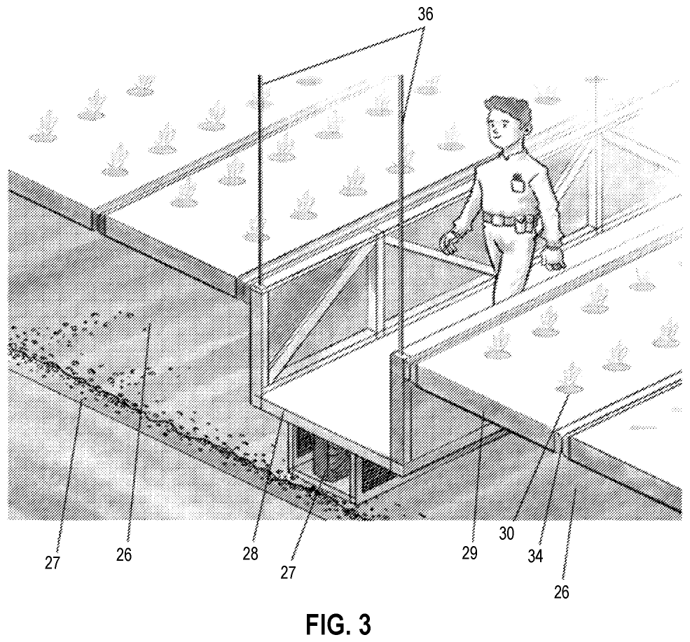

FIG. 3 is a schematic representation of a greenhouse showing a walkway. In FIG. 3, the walkway 28 is shown suspended by cables 36. The cable system is provided in connection with an embodiment of the invention that robotically rearranges the tables 29 and walkway.

The plenum 26 has a base that, in embodiments, comprises crushed rock 27 or other materials that add thermal mass to the greenhouse. In this embodiment, the base acts as a large thermal buffer and mediates thermal excursions. Loose stones, water pipes, or water containers may be placed on the bottom of the floor to create a thermal reservoir that keeps the temperature fairly constant so that if for instance, there is a cool night followed by a warm day, some of the cooling from the night can brought to the day and some of the warmth from the day can be brought to the night.

The tables 29 shown in FIG. 3 are separated by resilient members 34 which provide a seal to confine the conditioned air in the plenum. In this way, the conditioned air rises through vents in the tables themselves and more reliably contacts the plants 30.

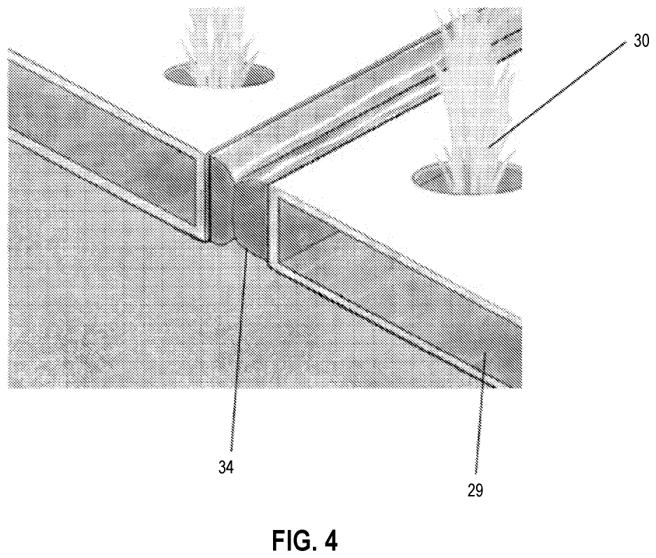

FIG. 4 provides a more detailed view of the tables and resilient seals.

### Ducting Air Under Tables

In embodiments, grow tables are ~40′ long running East/West. The East/West arrangement of the grow tables allows the plants to be fully exposed to the sun during its entire East/West transit of the sky.

In an embodiment, the tables are arranged to slide apart and together selectively to create an opening for one or more East/West access aisles. The tables may be positioned through human manipulation, or they may be positioned with a robotic or other such positioning system, e.g. tracks and rails, etc. The tops of grow tables are elevated sufficiently to leave sufficient clearance to establish a plenum for ventilation under the tables.

There are several embodiments of the table lifting system. In one approach, the aisle is lifted up and above the tables; in another approach, the aisle folds down and is moved underneath the tables. In another approach, the tables are on wheels and/or rails for sliding. In yet another approach, the tables are on legs that rest directly on rails near the tabletop, or some combination of the above. In another embodiment, a moving system lifts the tables slightly to unweight the tables so that the aisle can slide under the tables without contact. Other embodiments combine wheels toward one end of the table and the lifting system on the other end of the table, where the wheels are not necessarily on the ends of the table but are in the middle of the table. In still further embodiments, the tables can be lifted from any of above, below, or the side.

In the embodiment where the walkway is suspended, the walkway can be lifted up to reconfigure the tables to move the walkway, the tables are slid over sideways to establish a gap at the point where the walkway is to be inserted, the walkway is slid over to the gap, and then the walkway is lowered back into an operating position.

In another embodiment, the tables can be pulled up or the walkway can be lowered or collapsed and the walkway slides under the tables.

In each case the tables slide sideways to open up a gap for the walkway. Thus, the table slides sideways and is moved to the end of the space where the aisle was, and the aisle moves someplace else. In an embodiment, the table folds under and slides sideways. All such motion can be accomplished robotically, e.g. with a conveyance mechanism that effects coordinated displacement and movement of the tables and walkway, or it can be accomplished mechanically or manually.

In embodiments, the walkway is constructed to provide a vertical wall to maintain the plenum which, if not necessarily an impermeable wall, is nonetheless a barrier with a pressure differential across it.

In another embodiment a mechanism is provided to turn off the pressurization of the plenum while moving the aisles to prevent air leaking out of the plenum under pressure.

Another embodiment seals off the aisle with an airlock system so that the aisle remains sealed while it is moving. In this embodiment there is never a moment when the plenum is unsealed.

In another embodiment, the edges of the tables have a conforming resilient material that runs along them to create a partial seal. The seal can be a conformant seal, e.g. a piece of metal, a maze seal that interlocks, a pressure seal, or the tables could be close to each other so that the gap between them is relatively small, e.g. a partial seal.

The air has to flow out of the plenum upward. From the plenum some of the air flows upward between the tables which is acceptable because a key point of the system is to let the air flow upwards as long as the system maintains a fairly constant pressure under the plenum.

There is a fairly low pressure drop between one side of the plenum and the other. Although the pressure drop can be adjusted with an adjustable baffle and/or with fans. One advantage of the system is that there is a very large plenum area. Because the system uses the plenum and the system circulates the air uniformly underneath the tables, the air rises upwardly as desired.

The air gets hotter (or cooler) as it rises but the system still maintains a better temperature gradient than if the air was forced across the plants from up above as in a conventional greenhouse ventilation system. Uniquely, embodiments of the invention form a vent pipe by the table, i.e. the table themselves form the vent pipe.

In another embodiment a continuous piece of film is stretched in the plenum as a diffuser. The film always stays below the aisle. In this way a pressurized area is maintained by the film between the ground and the aisle. The film is a diffuser that allows air to diffuse constantly upward. This embodiment addresses the loss of pressure while moving the aisles, e.g. by turning off the pressure when moving the aisle. In this embodiment, the film is permanently positioned and stretches from one end of the plenum to the other end of the plenum under the aisle. There is a gap under the aisle in which fans are placed. Instead of a table stand, there is a piece of film that has holes in it that acts as a diffuser. The pressure differential established by the film helps to maintain a constant pressure in the plenum while the aisle is moved. In this embodiment, the aisle sits on top of or otherwise above the film. In essence the plenum is divided and airflow therein is not interrupted by the change of the aisle which is connected by a diffuser with the plenum. This embodiment only disrupts the plenum when the aisle is moved. There may be fans above the film to maintain an air flow but the film itself performs a similar function. In any event, the tabletops and the ground define the plenum. The film provides a divider and/or diffuser to mediate airflow in the plenum. The film may be mounted to the tables, it may be a continuous film below the tables, or it may be mounted to the tables and positioned below the tables as well.

Embodiments of the invention maintain a specific rate of flow or change the rate of flow by pulsing the air pressure, for example to control the humidity in the greenhouse. Embodiments also provide for injecting other elements into the greenhouse that might be beneficial to the plants, either dissolved in the air or as an air injected aerosol. For example, CO2 could be injected to enrich the growing of the plants. The process of conditioning the temperature is only one of the variables that can be controlled, e.g. humidity controls the gases in the air, or the system may control the aerosols. The conditioning point and circulation of conditioned air through the plenum provides a controllable velocity on the plants, which is typically but not always a uniform velocity on the plants. While air normally flows upwards from the plenum, in embodiments of the invention air can be directed sideways at the plants if more air is needed on the plants or air can be redirected in different directions on to the plants, for example by the way in which the vents work with the tables, e.g. the plants have a vent that faces at an angle such as an elbow that turns 90 degrees if it is desired to direct the air flow sideways.

In embodiments, the air flow can be reversed to draw the air out of the greenhouse, e.g. to draw air in through vents in the roof to introduce ambient air into the greenhouse, e.g. for dehumidification to dry out the plants. Or if there is a big swing in temperature in the greenhouse it is possible to change out the air in the greenhouse as quickly as possible, for example by creating a negative pressure in the plenum. In such case, the air supply pump in reversable. In embodiments of the invention greenhouse ventilation can be controlled by a servo system that uses sensors to monitor air that is introduced into the greenhouse from the plenum and from the roof vents and, based on ideal growing conditions, the servo system could change the direction of air flow as necessary.

Embodiments of the invention pump in air from above by reversing the air flow from the plenum, i.e. the plenum has negative pressure. In other embodiments, even if the plenum has positive pressure, air can be pumped from both sides of the plenum or from either side of the plenum. For example, there can be an air conditioner at one end of the plenum and a heater at the other end of the plenum. The ventilation system pumps air from both sides of the plenum and the quality of each air at each end of the plenum is different, e.g. warm air at one end and cool air at the other end. This arrangement could be particularly useful where different types of equipment are used in different seasons of the year. It is not necessary to put the equipment in series because the side with the air conditioner is operated in the summer and the side with the heater is operated in the winter.

Embodiments of the invention also place a wall at a point in the middle of the plenum and the aisle could be alternately moved between the warm side of the wall and the cold side of the wall; or a separate aisle could be provided on each side of the wall. This approach would be useful when growing different crops in each side of the greenhouse where crops that require different temperatures are grown in different bays; or the greenhouse could be split down the middle for different crops or different stages of maturity.

Some embodiments provide multiple aisles. The aisles are only used for people access so it depends on how much people access is needed. If the system is completely automated or there is a way of suspending the people over the tables, then aisles are not needed, and more space is available in the greenhouse to grow crops.

### Multiple Indoor Shades

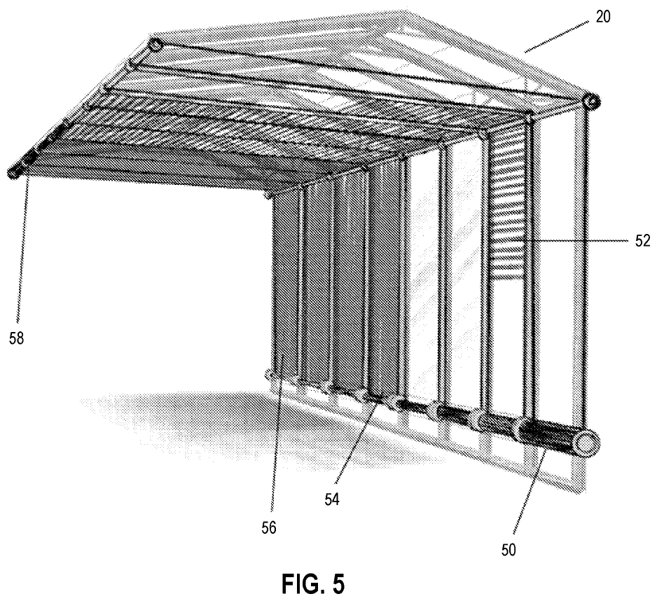

FIG. 5 is a schematic diagram showing an indoor shade arrangement for use in a greenhouse according to the invention. In an embodiment of the invention the shades are enabled by the under-table air conditioning system described above. The shades may be provided in combination with, or apart from the under-table system.

In an embodiment, there are multiple shades 50, 52, 54, 56, 58 on rolls below the plant tables (not shown in FIG. 5). The shades are deployed as needed in hot or cold weather. Deployment can be automated or programmatic based on sensed ambient conditions. Such deployment can be coordinated with operation of the air conditioning system described above and both the shades and operation of the plenum can be adjusted in real time, for example based on sensor readings.

The shades can be deployed to enable the use of IR blocking film in summer and as insulating blankets to keep heat in on cold winter nights. In embodiments separate rolls are used for IR blocking or insulation while other embodiments can include both IR blocking and insulating materials sequentially on the same roll. In embodiments of the invention, the shades are reflective on their upper surface to deflect sunlight that would overheat the greenhouse and have low emissivity on their lower surface to prevent the heat in the rising air from being reflected back to the plants. In embodiments, the shade can be reflective, but also let light into the greenhouse, e.g. the shade can block certain portions of the light spectrum such as infrared light and allow other portions of the light spectrum to reach the plants to stimulate growth. In other embodiments, the shades have low emissivity of their upper surface and reflect heat downwardly from their lower surface to enhance warming of the plants in cold weather.

As shown in FIG. 5, the shades may be positioned selectively to provide more or less shade to different portions of the greenhouse, e.g. to shade the top of the greenhouse more, to shade the sides of the greenhouse more, shade individual sections of the greenhouse, etc. The shades can be moved in response to actual conditions, e.g. to track the sun, to allow for clouds, etc.

In operation, the air is moving upward cools (or warms) the plants. Because of the shades any heating that takes place between the shades and the roof does not touch the plants. The shades have openings in them that air can flow through. In embodiments, there is also an exhaust fan at the top of the roof and/or a closeable vent that is most typically hinged to the peak of the roof. Any of the shades, exhaust fan, and the hinged vents can be operated automatically under control of a thermostat or other sensing and control system and such operation can be coordinated with operation of the plenum.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the invention as set forth in the following claims.

I/We claim:

1. A greenhouse thermal control apparatus, comprising:
a plurality of tables that support plants in said greenhouse, said tables arranged to create an under-table vault comprising a plenum, said plenum comprising an under-table airflow system into which conditioned air is introduced from a conditioned air source;
wherein said conditioned air rises vertically from said plenum and is evenly circulated among each of the plants as it rises; and
wherein a significant thermal differential between the plants is avoided by warming or cooling of the conditioned air as the conditioned air rises evenly through the plants.

2. The apparatus of claim 1, further comprising:
a robotic mechanism for rearranging said tables to provide access to said plants while maintaining said plenum.

3. The apparatus of claim 1, further comprising
an internal shading system within said greenhouse.

4. The apparatus of claim 1, further comprising:
at least one adjustable vent in at least one of the tables, wherein said at least one adjustable vent is operable to alter the volume and/or direction of a flow of said conditioned air.

5. The apparatus of claim 4, wherein said at least one adjustable vent is operable to provide different cooling or heating profiles for the plants on said at least one of the tables.

6. A greenhouse thermal control apparatus, comprising:
a plurality of tables within the greenhouse on which plants are grown;
wherein the tables are elevated and positioned adjacent to each other to form a continuous plenum between the ground and the tops of the tables; and
said plenum comprising an under table airflow system in which conditioned air, either warmed or cooled, is blown.

7. The apparatus of claim 6, further comprising:
a diffuser comprising:
a plurality of operable air exhaust vents, at least one of said air exhaust vents located in each of said plurality of said tables;
wherein said air exhaust vents are adjustable to alter the volume and/or direction of air flow as desired; and
wherein distribution of air from the plenum is constant or individually adjusted by variably positioning and/or opening or closing said air exhaust vents along or about the table surface.

8. The apparatus of claim 7, wherein said air exhaust vents are adjustable to provide different cooling or heating profiles for the plants on each table.

9. The apparatus of claim 6, wherein the tables are movable to open up a space between the tables to position an aisle between the tables.

10. The apparatus of claim 9, further comprising:
a conveyance mechanism configured to effect coordinated displacement and movement of the tables;
wherein movement of the table is effected any of robotically, mechanically, or manually.

11. The apparatus of claim 9, wherein the aisle maintains the integrity of the plenum, wherein continuity of the plenum is not broken by introduction of the aisle.

12. The apparatus of claim 9, wherein the tables are movable by any of moving the tables, sliding the tables, and moving the aisles.

13. The apparatus of claim 6, wherein the tables are attached to plumbing and electrical or other utilities.

14. The apparatus of claim 9, further comprising:
tethers attached at one end of the table with which the tables are movable to the left or the right to make room for the aisle as it is shifted between the tables.

15. The apparatus of claim 9, further comprising:
one or more fans associated with one or more aisles that are operable to make up for any pressure differential between one side of the aisle and the other.

16. The apparatus of claim 6, further comprising:
an air conditioner that cools or warms air that is drawn into the greenhouse.

17. The apparatus of claim 6, further comprising:
one or more adjustable roof vents in said greenhouse roof that allow warm air to escape the greenhouse.

18. The apparatus of claim 17, further comprising:
one or more reversible exhaust fans associated with said one or more adjustable roof vents;
wherein air is any of discharged from or drawn into the greenhouse through the one or more adjustable roof vents in the greenhouse roof.

19. The apparatus of claim 17, further comprising:
a walkway to allow access to the plants.

20. The apparatus of claim 19, further comprising:
a fan operable to compensate for a pressure differential that results from air restriction in the plenum caused by the walkway.

21. The apparatus of claim 6, said plenum further comprising:
a base comprising crushed rock or other materials to add thermal mass to the greenhouse;
wherein the base comprises a large thermal buffer that mediates thermal excursions in the greenhouse.

22. The apparatus of claim 7, further comprising:
conforming resilient members along the table edges and arranged between the tables to separate the tables and create at least a partial seal to confine the conditioned air within the plenum.

23. The apparatus of claim 6, wherein the tables have an East/West arrangement to allow the plants to be fully exposed to the sun during its entire East/West transit of the sky; and
wherein the tables are arranged to slide apart and together selectively to create an opening for one or more East/West access aisles.

24. The apparatus of claim 6, further comprising:
a table positioning system comprising any of:
an aisle that is lifted up and above the tables;
an aisle that is folded down and is moved underneath the tables;
wheels and/or rails for rolling or sliding the tables;
table legs that rest directly on rails near a tabletop;
a moving system configured to lift the tables slightly to unweight the tables so that an aisle can slide under the tables without contact;
a combination of wheels toward one end of the table and a lifting system on the other end of the table, wherein the wheels are in the middle of the table;
a lifting system with which the tables are lifted from any of above, below, or the side;
a suspended walkway configured to be lifted up to reconfigure the tables to move the walkway, wherein the tables are slid over sideways to establish a gap at a point where the walkway is to be inserted, the walkway is slid over to the gap, and then the walkway is lowered back into an operating position;
a system with which the table folds under and slides sideways; and
a lifting system with which the tables are pulled up or the walkway is lowered or collapsed and the walkway slides under the tables.

25. The apparatus of claim 19, wherein the tables are movable to slide sideways to open up a gap for the walkway, wherein the table slides sideways and is moved to an end of a space where the aisle was, and the aisle moves to another space.

26. The apparatus of claim 19, said walkway further comprising:
a vertical wall configured to maintain the plenum by providing a barrier having a pressure differential across the wall.

27. The apparatus of claim 26, further comprising:
a mechanism operable to turn off pressurization of the plenum while moving the aisles to prevent air leaking out of the plenum under pressure.

28. The apparatus of claim 19, further comprising:
an airlock system operable to seal off the aisle, wherein the aisle remains sealed while it is moving.

29. The apparatus of claim 28, further comprising:
a continuous piece of film stretched in the plenum as a diffuser;
wherein the film is located below the aisle;
wherein a pressurized area is maintained by the film between a ground and the aisle;
the film comprising a diffuser with which air diffuses constantly upward to prevent a loss of pressure while moving the aisles;
wherein the film is permanently positioned and stretches from one end of the plenum to another end of the plenum under the aisle; and
wherein there is a gap under the aisle in which fans are placed.

30. The apparatus of claim 6, further comprising:
a mechanism operable to pulse air pressure within the plenum to maintain a specific rate of air flow or change the rate of air flow.

31. The apparatus of claim 6, further comprising:
a mechanism operable to inject other elements into the greenhouse, either dissolved in the air or as an air injected aerosol.

32. The apparatus of claim 7, wherein air flow is reversible to draw air out of the greenhouse by drawing air in through vents in the greenhouse roof to introduce ambient air into the greenhouse by creating a negative pressure in the plenum.

33. The apparatus of claim 6, further comprising:
a servo system comprising sensors that monitor air that is introduced into the greenhouse from the plenum and from roof vents and, based on ideal growing conditions, the servo system is operable change the direction of air flow as necessary.

34. The apparatus of claim 6, wherein the plenum is configured to pump air from both sides of the plenum or from either side of the plenum;
wherein the quality of air at each side of the plenum is independent of the air quality for the other side of the plenum.

35. The apparatus of claim 6, further comprising:
a wall positioned at a point in or near a middle of the plenum; and
either an aisle that is alternately movable between a warm side of the wall and a cold side of the wall, or a separate aisle on each side of the wall.

36. The apparatus of claim 6, further comprising:
an indoor shade arrangement operable in combination with, or apart from the plenum.

37. The apparatus of claim 36, further comprising:
a plurality of shades on rolls below the plant tables.

38. The apparatus of claim 37, wherein the shades are deployed as needed by an automated or programmatic controller based on sensed ambient conditions.

39. The apparatus of claim 38, wherein said deployment is coordinated with operation of the plenum in real time.

40. The apparatus of claim 37, further comprising:
shades that are deployed to enable use of an IR blocking film in summer and as insulating blankets to keep heat in winter.

41. The apparatus of claim 40, said shades further comprising any of:
separate rolls used for IR blocking or insulation, or both IR blocking and insulating materials sequentially on a same roll.

42. The apparatus of claim 37, said shades further comprising any of:
a reflective upper surface to deflect sunlight that would overheat the greenhouse and a low emissivity lower surface to prevent heat in the rising air from being reflected back to the plants;
a reflective surface that lets light into the greenhouse, wherein the shade blocks certain portions of the light spectrum and allows other portions of the light spectrum to reach the plants to stimulate growth; and
a low emissivity upper surface and a lower surface to reflect heat downwardly to enhance warming of the plants.

43. The apparatus of claim 36, wherein the shades are operable for selective positioning to provide more or less shade to different portions of the greenhouse.

44. The apparatus of claim 36, wherein the shades are operable in response to current ambient conditions.

45. The apparatus of claim 36, wherein shades comprise openings through which air can flow.

46. The apparatus of claim 6, further comprising:
shades, an exhaust fan, and hinged roof vents, each of which is automatically operable under control of a thermostat or other sensing and control system; and
wherein said operation is coordinated with operation of the plenum.
